(19) United States
(12) Patent Application Publication
(10) Pub. No.: US 2026/0158974 A1
(43) Pub. Date: Jun. 11, 2026

(54) MESH VEHICLE SEATING

(71) Applicant: American EV, LLC, Jacksonville, FL (US)

(72) Inventors: Aric Singletary, Yulee, FL (US); Ryan Nixon, Austin, TX (US); Ryan Baskerville, Atlantic Beach, FL (US); Jessica Butler, Callahan, FL (US)

(21) Appl. No.: 19/415,259

(22) Filed: Dec. 10, 2025

Related U.S. Application Data
(60) Provisional application No. 63/730,820, filed on Dec. 11, 2024.

(51) Int. Cl. B60N 2/24; B60N 2/06; B60N 2/68; B60N 2/70

(52) U.S. Cl. CPC B60N 2/24; B60N 2/06; B60N 2/682; B60N 2/7011

(57) ABSTRACT

A seating assembly for a vehicle may include a back portion and a bottom portion, each having a mesh fabric supported by a fabric frame. The fabric frame may include multiple portions oriented along different planes to permit contoured ergonomic support, and may define a main venting opening and side venting openings configured to direct airflow through the mesh fabric toward a seated user. A seat frame may support the seating assembly and may include a slider mechanism for positional adjustment. The back and bottom portions may pivot relative to one another or may be arranged at a fixed angle. The mesh fabric may provide breathability, rapid drainage, and improved weight distribution.

### CROSS-REFERENCES TO RELATED APPLICATIONS

This application claims priority to U.S. Provisional Patent Application Ser. No. 63/730,820 filed Dec. 11, 2024, the entirety of which is incorporated by reference herein.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

### 1. Field of the Invention

The invention pertains to seating in light electric vehicles, personal transportation vehicles, utility task vehicles, lightweight utility vehicles, low-speed vehicles, medium-speed vehicles, and neighborhood electric vehicles. More specifically, the invention pertains to mesh seating in light electric vehicles, personal transportation vehicles, utility task vehicles, lightweight utility vehicles, low-speed vehicles, medium-speed vehicles, and neighborhood electric vehicles.

### 2. Description of the Prior Art

Current seating options used in utility task vehicles (UTVs), low-speed vehicles (LSVs), lightweight electric vehicles (LEVs), medium-speed vehicles (MSVs), and neighborhood electric vehicles (NEVs), and similar platforms can become uncomfortable in hot environments or when users are wet. Traditional seat constructions are often heavy, rely on foam padding that retains heat, and become saturated with water when exposed to rain, humidity, or moisture from beaches, marinas, and recreational environments. Foam-based seats may also lose support over time, causing user discomfort during extended use, and their smooth upper surfaces frequently allow users to slide laterally during cornering or dynamic vehicle maneuvers.

Prior attempts to solve these problems have been largely unsuccessful. Vinyl-covered foam seats do not breathe or allow water to drain, causing heat buildup and prolonged drying times. The geometry of foam cushions dictates user contact points and therefore creates inconsistent or uncomfortable pressure regions that may not accommodate different body types. When foam becomes waterlogged, it can promote mold growth, increase seat weight, and permit water to migrate toward nearby electronic components of the vehicle. Many prior-art seats incorporate wood or composite backing boards that degrade, rot, or delaminate when exposed to high humidity, salt environments, or repeated wet-dry cycles.

Conventional automotive seating technologies also fail to address the needs of open-air or partially enclosed vehicles. Automotive manufacturers commonly use cloth- or leather-covered foam seats, which rely on doors, windows, and HVAC systems to maintain a dry and comfortable cabin. These seats are not designed for frequent outdoor exposure and are susceptible to UV degradation, moisture absorption, and thermal discomfort. Although some automotive systems incorporate internal fans or Peltier coolers to improve comfort, such systems add cost, complexity, and weight, and they do not address the fundamental issue of trapping heat and moisture inside the seat structure.

Suspension seating used in off-road vehicles typically employs a network of cords or straps beneath a foam cushion to absorb impacts and improve ride comfort. While this configuration may enhance shock absorption, the presence of foam still limits airflow, retains moisture, and requires the inclusion of bolsters or rigid shaping to maintain user support. The suspension structures do not eliminate the drawbacks associated with foam, and they do not provide meaningful airflow or drainage through the seating surface.

Simple mesh seating used in boating applications introduces some breathability but is generally designed for non-ergonomic, static seating environments. These mesh seats commonly rely on rigid metal frames with limited contouring capability and do not integrate elastic or partially elastic mesh materials configured to distribute user weight. Such designs often lack precision-molded or overmolded structures, features that are necessary to achieve multi-plane support geometries, controlled mesh tensioning, and enhanced seating ergonomics. Additionally, boating mesh seats typically do not incorporate airflow-directing vent openings or structures engineered for integration into modern recreational or electric vehicle platforms.

### BRIEF SUMMARY

In view of at least some of the above-referenced problems with conventional seating used in UTVs, LSVs, LEVs, MSVs, NEVs, and similar vehicles, including discomfort from heat retention, inadequate ventilation, moisture accumulation, and excessive seat weight, an exemplary object of the present disclosure may be to provide a new and improved seating assembly configured to enhance airflow, drainage, ergonomics, durability, and overall user comfort.

UTVs, LSVs, LEVs, MSVs, NEVs, and similar vehicles are often operated in warm, humid, or coastal regions such as Florida, Texas, and Arizona. These environments expose vehicle occupants to high ambient temperatures, solar load, frequent rain events, and moisture from beaches, marinas, golf courses, and resort areas. Traditional vinyl-covered foam seating absorbs heat, restricts ventilation, and becomes uncomfortable when wet, especially during prolonged operation. In contrast, the mesh seating assemblies of the present disclosure are specifically engineered to address these environmental and ergonomic challenges through improved airflow, drainage, weight reduction, and pressure distribution.

In a particular embodiment, an exemplary seating assembly may include a back portion and a bottom portion, each provided with a mesh fabric supported by a corresponding fabric frame. A seat frame may support at least the bottom portion and may additionally support the back portion, permitting the seating assembly to be mounted to a vehicle.

In an exemplary aspect according to the above-referenced embodiment, a pivoting mechanism may be positioned between the back portion and the bottom portion to permit relative movement between the two portions.

In an exemplary aspect according to the above-referenced embodiment, the bottom portion may be configured to pivot or fold toward the back portion, such as for storage, access, or compact stowing of the seating assembly.

In an exemplary aspect according to the above-referenced embodiment, the back portion may be configured to pivot or fold toward the bottom portion, permitting reclining, collapsing, or compact transport of the assembly.

In an exemplary aspect according to the above-referenced embodiment, the back portion and the bottom portion may be arranged at a fixed angle, providing a rigid ergonomic geometry without moving components.

In an exemplary aspect according to the above-referenced embodiment, the back portion and the bottom portion may be formed as identical or interchangeable components to reduce tooling, simplify manufacturing, and streamline part replacement.

In an exemplary aspect according to the above-referenced embodiment, each fabric frame may include multiple supporting regions configured to carry different portions of the mesh fabric in planes that may be oriented differently from one another to define a contoured seating surface. For example, the fabric frame of each of the back portion and the bottom portion may include a first portion configured to support a first mesh portion of the mesh fabric parallel to a first plane, a second portion configured to support a second mesh portion of the mesh fabric parallel to a second plane, and a third portion configured to support a third mesh portion of the mesh fabric parallel to a third plane.

In an exemplary aspect according to the above-referenced embodiment, the planes associated with the supporting regions may be oblique, enabling transition zones that contribute to user comfort and posture support. For example, in certain optional embodiments, the first plane may be oblique to the second plane, and the second plane may be oblique to the third plane. In certain other optional embodiments, the first plane may be oblique to the third plane.

In an exemplary aspect according to the above-referenced embodiment, the supporting regions of the fabric frame may be sized differently, such as by enlarging selected regions to provide greater structural support or targeted mesh tensioning. For example, the second portion of the fabric frame may be larger than the first portion, and the third portion of the fabric frame may be larger than the first portion.

In an exemplary aspect according to the above-referenced embodiment, the fabric frame of each portion may define a main venting opening and multiple side venting openings, all of which may be covered by the mesh fabric and contribute to passive airflow and moisture drainage.

In an exemplary aspect according to the above-referenced embodiment, the mesh fabric may be formed from a UV-resistant material having elasticity or partial elasticity to promote comfort, durability, and rapid drying.

In an exemplary aspect according to the above-referenced embodiment, the fabric frame may be a molded polymer structure configured to support the perimeter of the mesh fabric securely.

In an exemplary aspect according to the above-referenced embodiment, the fabric frame may alternatively be formed from extruded metal rails that secure the mesh fabric and provide a rigid border.

In an exemplary aspect according to the above-referenced embodiment, the seating assembly may include a seat slider mechanism configured to allow forward and rearward adjustment of the seating position relative to the vehicle.

In an exemplary aspect according to the above-referenced embodiment, the seating assembly may be suitable for use in numerous vehicle categories, including light electric vehicles, personal transportation vehicles, utility terrain vehicles, low-speed vehicles, medium-speed vehicles, and/or neighborhood electric vehicles.

In another embodiment, an exemplary seating assembly may include a mesh fabric, a fabric frame supporting the mesh fabric, a seat frame configured to mount the assembly to a vehicle, and an airflow system configured to direct air through the mesh fabric toward a seated occupant to enhance comfort.

In an exemplary aspect according to the above-referenced embodiment, the airflow system may direct air through the mesh fabric of a bottom portion to provide cooling or ventilation to the legs and lower body of the occupant.

In an exemplary aspect according to the above-referenced embodiment, the airflow system may direct air through the mesh fabric of a back portion to provide cooling, drying, or ventilation along the user's back and torso.

In another embodiment, an exemplary seating component may include a mesh fabric supported by a fabric frame having multiple regions arranged along different planes, at least two of which may be oblique to one another to define a sculpted or ergonomically contoured support surface. The fabric frame may include a first portion supporting a first part of the mesh fabric parallel to a first plane, a second portion supporting a second part of the mesh fabric parallel to a second plane, and a third portion supporting a third part of the mesh fabric parallel to a third plane.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 is a front perspective view of an embodiment of an improved electric vehicle in accordance with the present disclosure.

FIG. 2 is a partially exploded side view of the improved electric vehicle of FIG. 1 in accordance with the present disclosure.

FIG. 3 is a front perspective view of an embodiment of a seating assembly of the improved electric vehicle of FIG. 1 in accordance with the present disclosure.

FIG. 4 is a rear perspective view of the seating assembly of FIG. 3 in accordance with the present disclosure.

FIG. 5 is a front elevation view of the seating assembly of FIG. 3 in accordance with the present disclosure.

FIG. 6 is a side elevation view of the seating assembly of FIG. 3 in accordance with the present disclosure.

FIG. 7 a side elevation view of an embodiment of the seating assembly of FIG. 3 in accordance with the present disclosure.

FIG. 8 is a front perspective view of the seating assembly of FIG. 3 with mesh removed in accordance with the present disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a”, “an” and “the” are intended to include the plural forms as well, unless the context clearly indicates otherwise.

Spatially relative terms, such as “under”, “below”, “lower”, “over”, “upper” and the like, may be used herein for ease of description to describe one element or feature's relationship to another when the apparatus is right side up.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer list (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. Importantly, this term excludes such other elements that adversely affect the operability of what is claimed for its intended purpose as stated in this disclosure, even if such other elements might enhance the operability of what is claimed for some other purpose.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

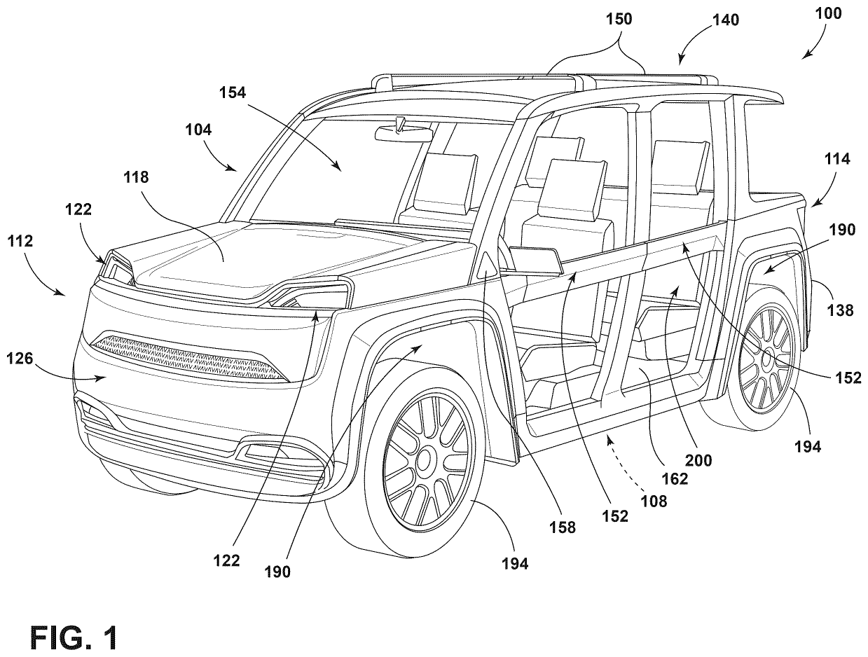

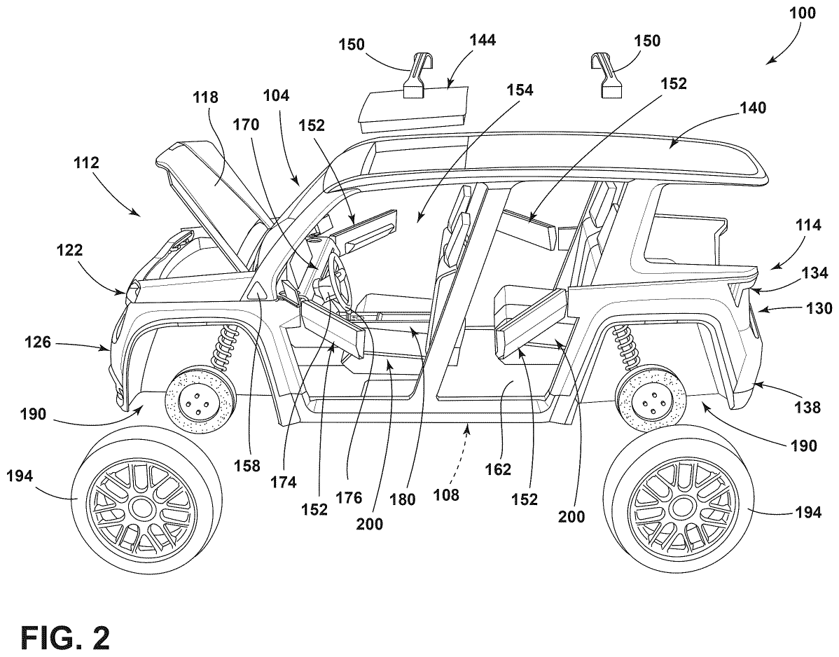

Referring to FIGS. 1-2, an exemplary improved electric vehicle 100 is shown. The electric vehicle 100 may include a vehicle body 104 coupled with a chassis 108. It will be understood that the electric vehicle 100 may be configured as a utility task vehicle (UTV), a low-speed vehicles (LSV), a lightweight electric vehicle (LEV), a medium-speed vehicle (MSV), and/or a neighborhood electric vehicle (NEV).

The body 104 may include a front portion 112 and a rear portion 114. The front portion 112 may include a front hood 118 and one or more headlight assemblies 122. The front portion 112 may further include a forward bumper 126. The rear portion 114 of the body 104 may include a tailgate assembly 130 and one or more taillight assemblies 134. The rear portion 114 may further include a rear fender 138.

The vehicle 100 may further include a roof assembly 140 extending between the front portion 112 and the rear portion 114 of the body 104. The roof assembly 140 may be operably coupled with the body 104. Alternatively, the roof assembly 140 may be integrally formed with the body 104. In various examples, the roof assembly 140 may include one or more roof panels 146 configured to at least partially form the roof of the vehicle 100. However, it will be understood that the roof assembly 140 may be a single panel or piece without departing from the scope of the present disclosure. In various examples, a roof rack and one or more rails 150 may be operably coupled with the roof assembly 140 and/or one or more of the roof panels 146.

The vehicle 100 may include one or more door assemblies 152 configured to selectively allow access to an interior 154 of the body 104. The one or more door assemblies 152 may be operably coupled with the body 104 of the vehicle and may be movable between an open position (FIG. 2) and closed position (FIG. 1). For example, the one or more door assemblies 152 may be hingedly coupled with the body 104 of the vehicle 100. The one or more door assemblies 152 may be configured to fully cover an opening of the vehicle body 104 configured to allow ingress and egress to the interior 154 of the vehicle 100 or the one or more door assemblies 152 may be configured to partially cover an opening of the vehicle body 104 configured to allow ingress and egress to the interior 154 of the vehicle 100.

In various examples, the vehicle 100 may further include a charge port 158 configured to be selectively coupled with a vehicle charging source (not shown) to provide charge/recharge to a battery of the vehicle. It will be understood that the vehicle 100 may include a single battery for operating all of the components of the vehicle 100 or may include multiple batteries without departing from the scope of the present disclosure.

As previously introduced, the body 104 of the vehicle 100 may define an interior 154 of the vehicle 100. A floor 162 may be positioned within the interior 154 of the vehicle 100 proximate the chassis 108. A plurality of seating assemblies 200 may be operably coupled with the floor 162 of the vehicle 100 and may be arranged in one or more rows (e.g., a forward row of seating assemblies 200 and a rear row of seating assemblies 200, three rows, or any number of rows as determined by the layout of the vehicle 100).

As best shown in FIG. 2, the vehicle 100 may further include a vehicle dashboard 170 extending across the interior 154 of the vehicle 100 proximate the front portion 112 of the vehicle 100. The dashboard 170 may be configured to house electronics, storage assemblies, a vehicle gauge assembly, and/or other components of the vehicle 100. A steering column 174 may extend from the dashboard 170 proximate a seating assembly 200 and may be coupled with a steering wheel 176. However, it will be understood that the vehicle 100 may be operated using other control systems or features without departing from the scope of the present disclosure.

A center console 180 may be operably coupled with the dashboard 170. The center console 180 may include various components of the vehicle 100 such as, for example, storage compartments, a gear shifter, or additional electronics. In various examples, the center console 180 may be integrally formed with the dashboard 170 as a single component. In other examples, the center console 180 may be separate from the dashboard 170. It is contemplated that the vehicle 100 may not include a center console 180 or may include other components alternatively arranged without departing from the scope of the present disclosure.

Referring still to FIGS. 1 and 2, the body 104 of the vehicle 100 may further define one or more wheel wells 190 each configured to at least partially receive a wheel 194 of the vehicle 100. The wheels 194 of the vehicle 100 may be rotatably coupled with the chassis 108. It will be understood that the wheels 194 may be any type or size of wheel without departing from the scope of the present disclosure.

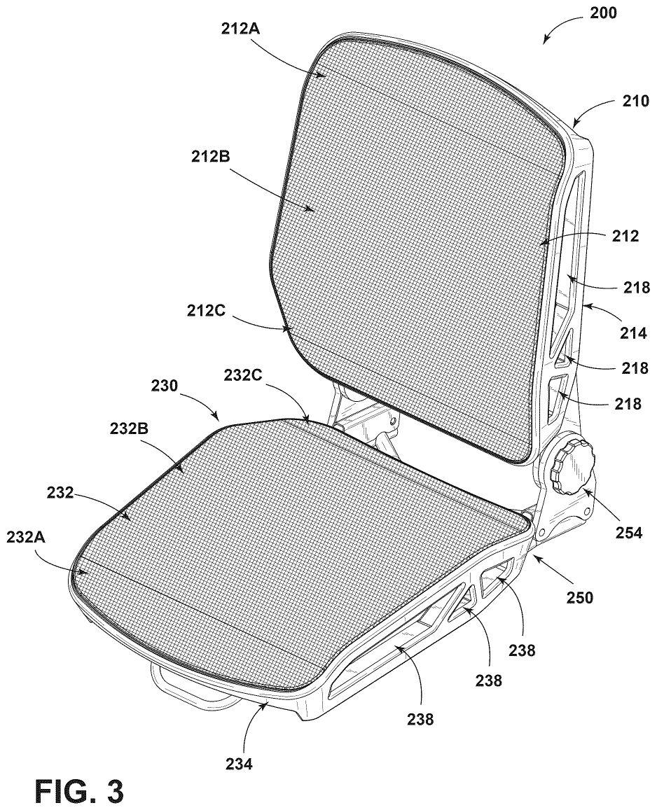

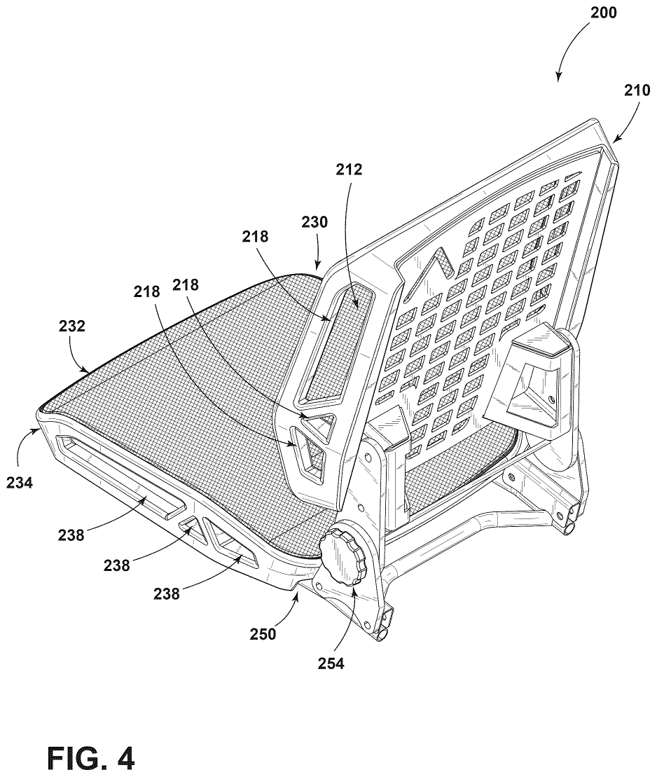

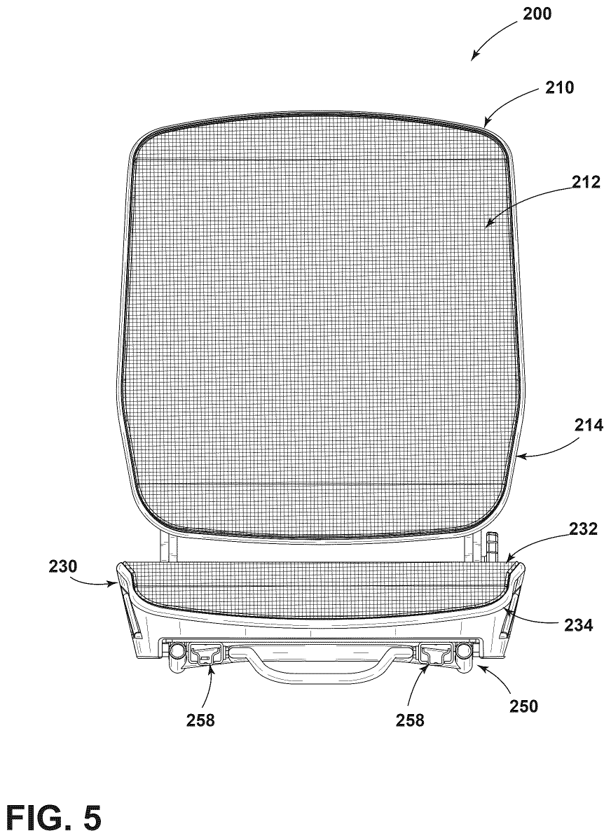

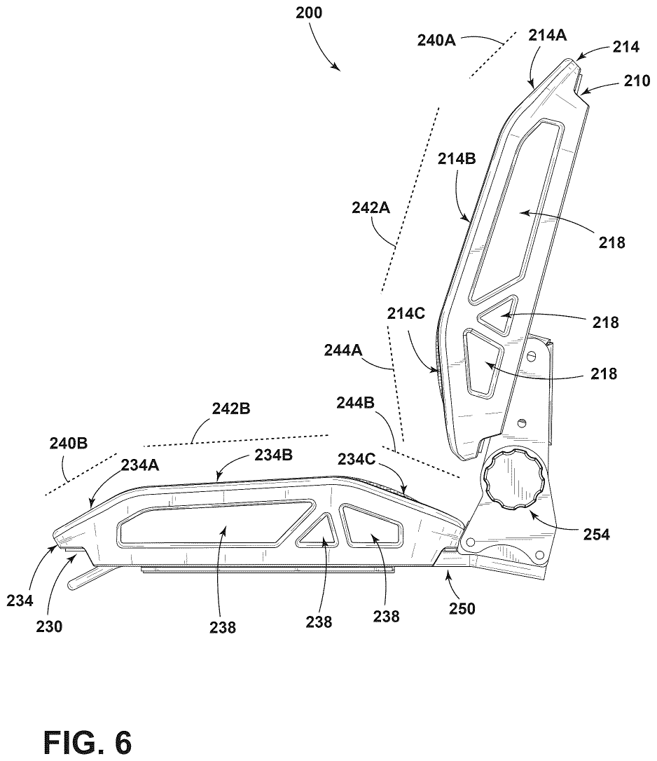

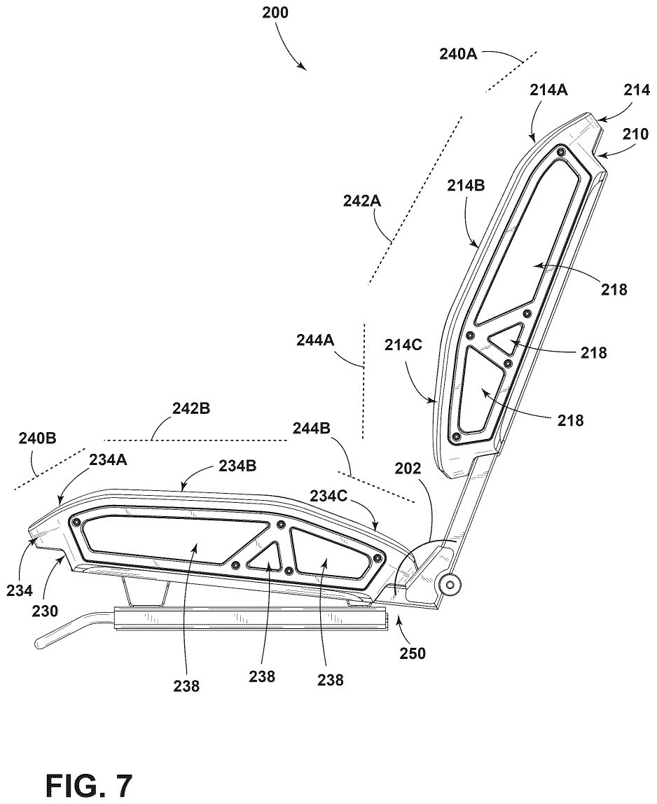

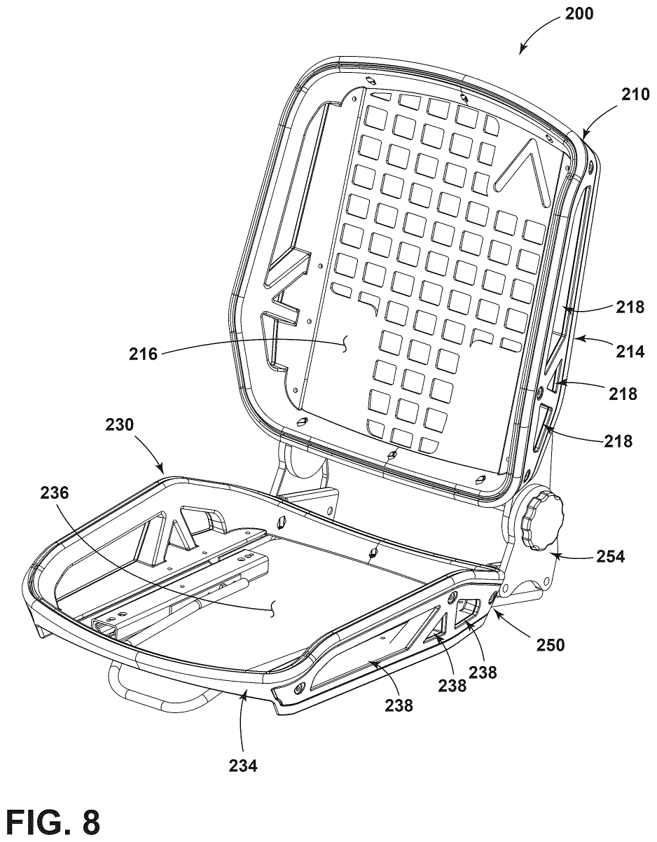

Referring to FIGS. 3-8, the seating assembly 200 may include a back portion 210 and a bottom portion 230 coupled to one another. Each portion may be formed as a distinct module or as identical components to simplify manufacturing. The back portion 210 supports the user's torso, while the bottom portion 230 supports the legs and pelvis. In some embodiments, as illustrated in FIG. 7, the back portion 210 and the bottom portion 230 may be arranged at a fixed angle 202. In other embodiments, as illustrated in FIGS. 3-6 and 8, a pivoting mechanism 254 may be provided between them to enable reclining, folding, or collapsing of the seating assembly. For example, the bottom portion 230 may be configured to pivot or fold upward toward the back portion 210, such as for storage, transport, or access to components beneath the seat. Conversely, the back portion 210 may be configured to pivot or fold downward toward the bottom portion 230 to enable reclining, collapsing, or compact stowing of the seating assembly. In certain embodiments, the pivoting mechanism 254 may accommodate movement in either direction.

Each of the back portion 210 and the bottom portion 230 may include a mesh fabric 212, 232. The mesh fabric may include an elastic, partially elastic, or flexible weave pattern configured to promote breathability and even weight distribution. The mesh fabric may comprise a UV-resistant elastic weave. As the vehicle 100 moves, air may flow through the mesh fabric, generating a passive cooling effect and reducing heat buildup. Because the mesh fabric does not trap moisture, any water introduced to the seat, such as from wet clothing or rainfall, drains freely, allowing the fabric to dry quickly and preventing waterlogging.

The mesh fabric 212, 232 may be supported by a fabric frame 214, 234. The fabric frame may be molded from polymeric materials, formed from extruded metal rails, optionally over molded, or manufactured using combinations thereof. In certain embodiments, each fabric frame includes multiple frame portions, such as a first portion 214A, 234A; a second portion 214B, 234B; and a third portion 214C, 234C, configured to support corresponding mesh fabric regions 212A-212C and 232A-232C. These portions may define a first plane 240A, 240B, a second plane 242A, 242B, and a third plane 244A, 244B, associated with each fabric frame 214, 234. The second portion 214B, 234B may be larger than the first portion 214A, 234A, and the third portion 214C, 234C may be larger than the first portion 214A, 234A, thereby providing expanded support surfaces for selected regions of the mesh fabric. At least two of these planes may be oblique to one another to create a contoured or faceted ergonomic seating surface. In certain optional embodiments, different tensioning characteristics may be applied across the mesh fabric to support the user's lumbar region, upper back, thighs, and hips.

The fabric frame 214, 234 may include a main venting opening 216, 236 positioned centrally and one or more side venting openings 218, 238 positioned along peripheral frame portions. These openings, collectively forming an airflow system, direct outside air into and through the mesh fabric to enhance breathability. The airflow system may be configured to direct air through the mesh fabric of the bottom portion 230 and through the mesh fabric of the back portion 210. The venting openings may be circular, slotted, polygonal, or patterned, and may be strategically arranged to optimize airflow toward specific areas of the user's body. In some embodiments, the airflow system is shaped to produce focused air channels, while in other embodiments an active airflow device such as a fan or blower may be integrated into the seat frame 250 or surrounding structure.

The seating assembly 200 may further include a seat frame 250 that supports at least the bottom portion 230 and may optionally support the back portion 210. The seat frame 250 may be fabricated from metal, composite materials, or combinations thereof, and is configured to attach to a vehicle 100 using brackets, bolts, screws, or other mounting hardware. In some embodiments, the seat frame includes reinforcement structures to interface with the vehicle chassis 108 or floor 162.

In certain embodiments, the seating assembly 200 may further include a seat slider mechanism 258 positioned between the seat frame 250 and the vehicle 100 to allow translation of the seating assembly forward or backward to accommodate users of different heights.

The mesh fabric may be formed from UV-resistant materials, including polyester, vinyl-coated polyester, nylon, a combinations thereof, or similar materials. These materials may be configured to withstand frequent sun exposure, salt spray, moisture, and temperature variation without significant degradation. The fabric frame may be molded or otherwise shaped with features enabling precise tensioning of the mesh fabric to ensure long-term resistance to stretching or sagging. Compared to foam seating, the present mesh seating assembly may provide improved airflow, more uniform weight distribution, greater durability, faster drying, reduced odor potential, and reduced sensitivity to environmental conditions.

In some embodiments, the seating assembly 200 may be removable from the seat frame 250 or detachable as a single integrated module. Such configurations enable the seating assembly to be used as an outdoor chair, beach chair, or utility seat. The rapid-drying mesh fabric and venting openings make the seat particularly suitable for recreational settings where exposure to moisture is common.

Although primarily described in connection with light electric vehicles, the seating assembly 200 may be used in a wide variety of platforms including personal transportation vehicles, neighborhood electric vehicles, utility terrain vehicles, low-speed vehicles, medium-speed vehicles, hunting vehicles, marine vessels, aircrafts, or the like. The improved airflow, ergonomic support, light weight, and environmental durability make the seating assembly suitable for both sealed cabin and open-air vehicle applications.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present disclosure have been described in detail, it will be understood by those skilled in the art that various modifications can be made therein without departing from the spirit and scope of the disclosure as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the disclosure. The principal features of this disclosure may be employed in various embodiments without departing from the scope of the disclosure. Those of ordinary skill in the art will recognize numerous equivalents to the specific procedures described herein. Such equivalents are considered to be within the scope of this disclosure and are covered by the claims.

All of the compositions and/or methods disclosed and claimed herein may be made and/or executed without undue experimentation in light of the present disclosure. While the compositions and methods of this disclosure have been described in terms of the embodiments included herein, it will be apparent to those of ordinary skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the spirit, scope, and concept of the disclosure as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A seating assembly, comprising:
a back portion and a bottom portion coupled to the back portion, each of the back portion and the bottom portion including:
a mesh fabric; and
a fabric frame supporting the mesh fabric; and
a seat frame supporting the bottom portion and optionally supporting the back portion, the seat frame configured to be attached to a vehicle.

2. The seating assembly of claim 1, further comprising:
a pivoting mechanism coupled between the back portion and the bottom portion.

3. The seating assembly of claim 2, wherein:
the bottom portion is configured to pivot towards the back portion using the pivoting mechanism.

4. The seating assembly of claim 2, wherein:
the back portion is configured to pivot towards the bottom portion using the pivoting mechanism.

5. The seating assembly of claim 1, wherein:
an angle of the back portion is fixed relative to the bottom portion.

6. The seating assembly of claim 1, wherein:
the back portion and the bottom portion are identical.

7. The seating assembly of claim 1, wherein:
the fabric frame of each of the back portion and the bottom portion include a first portion configured to support a first mesh portion of the mesh fabric parallel to a first plane, a second portion configured to support a second mesh portion of the mesh fabric parallel to a second plane, and a third portion configured to support a third mesh portion of the mesh fabric parallel to a third plane.

8. The seating assembly of claim 7, wherein:
the first plane is oblique to the second plane; and
the second plane is oblique to the third plane.

9. The seating assembly of claim 8, wherein:
the first plane is oblique to the third plane.

10. The seating assembly of claim 7, wherein:
the second portion of the fabric frame is larger than the first portion; and
the third portion of the fabric frame is larger than the first portion.

11. The seating assembly of claim 1, wherein:
the fabric frame includes a main venting opening covered by the mesh fabric; and
the fabric frame includes side portions having a plurality of side venting openings.

12. The seating assembly of claim 1, wherein:
the mesh fabric comprises a UV-resistant elastic weave.

13. The seating assembly of claim 1, wherein:
the fabric frame of each of the back portion and the bottom portion comprises a molded polymer structure configured to support a perimeter of the mesh fabric.

14. The seating assembly of claim 1, wherein:
the fabric frame of each of the back portion and the bottom portion comprises extruded metal rails configured to support a perimeter of the mesh fabric.

15. The seating assembly of claim 1, further comprising:
a seat slider mechanism coupled between the seat frame and the vehicle and further configured to permit the seating assembly to translate forward and backward relative to the vehicle.

16. The seating assembly of claim 1, wherein:
the vehicle is a light electric vehicle, a personal transportation vehicle, a utility terrain vehicle, a low-speed vehicle, a medium-speed vehicle, and/or a neighborhood electric vehicle.

17. A seating assembly, comprising:
a mesh fabric;
a fabric frame supporting the mesh fabric;
a seat frame configured to support the fabric frame and attach to a vehicle; and
an airflow system configured to direct air through the mesh fabric toward a user while seated.

18. The seating assembly of claim 17, further comprising:
a bottom portion supporting the mesh fabric, wherein the airflow system is configured to direct through the mesh fabric of the bottom portion.

19. The seating assembly of claim 17, further comprising:
a back portion supporting the mesh fabric, wherein the airflow system is configured to direct through the mesh fabric of the back portion.

20. A seating component for a vehicle, comprising:
a mesh fabric; and
a fabric frame supporting the mesh fabric, the fabric frame including:
a first portion supporting a first part of the mesh fabric parallel to a first plane,
a second portion supporting a second part of the mesh fabric parallel to a second plane, and
a third portion supporting a third part of the mesh fabric parallel to a third plane,
wherein at least two of the planes are oblique to one another.
